(19) United States
(12) Patent Application Publication
(10) Pub. No.: US 2002/0094134 A1
(43) Pub. Date: Jul. 18, 2002

(54) Method and system for placing three-dimensional models

(76) Inventors: Christopher Allen Nafis, Vischer Ferry, NY (US); William Edward Lorensen, Ballston Lake, NY (US); James Vradenburg Miller, Clifton Park, NY (US); Steven Eric Linthicum, Niskayuna, NY (US)

Correspondence Address: GENERAL ELECTRIC COMPANY, CRD PATENT DOCKET ROOM 4A59, P O BOX 8, BUILDING K 1 SALAMONE, SCHENECTADY, NY, 12301, US

(21) Appl. No.: 09/681,119

(22) Filed: Jan. 12, 2001

(51) Int. Cl. G06K 9/36; G06F 7/60

(52) U.S. Cl. 382/285; 703/2

(57) ABSTRACT

A method and system for creating three-dimensional models comprises the steps of generating a three-dimensional object model from a plurality of digital images of an object, creating three-dimensional coordinates from the plurality of images, identifying coordinates on a CAD model of a part which correspond to the three-dimensional coordinates, calculating a transformation matrix between the three-dimensional coordinates and the coordinates on the CAD model, and applying the transformation matrix to the CAD model to position, scale, and orient the CAD model in the object model, thus creating a composite model.

### BACKGROUND OF INVENTION

The present invention relates to the generation of three-dimensional models for large and/or complex objects, and particularly to the placement of three-dimensional part models on a three-dimensional object model.

Large industrial and commercial equipment exists for which no three-dimensional (3D) Computer Aided Design (CAD) models were created. Particularly, CAD models were not created in legacy systems because CAD systems and especially 3D CAD systems were unavailable or cost prohibitive at the time of design. As technology has progressed, the cost of 3D CAD systems has decreased while the availability, quality and capability of 3D CAD systems have significantly increased making it desirable to have 3D models for large/complex legacy systems. Although CAD systems are not all three-dimensional, CAD models in the context of this specification are all considered to be, by way of example, 3D models.

3D models of legacy systems enable the use of new engineering techniques to be applied to areas such as retrofitting, servicing, assembly, maintainability, and the like of these systems. However, conventional methods for creating such 3D models involve laborious and costly processes such as generating individual 3D part models from existing two dimensional (2D) drawings. The individual parts then need to each be oriented in a 3D assembly, which is also generated manually from a set of 2D assembly drawings or by exhaustive physical measurement of an existing system.

The field of photogrammetry addresses the ability of generating 3D measurements directly from a series of 2D images, typically photographs. Two basic techniques exist for applying photogrammetric theory. The first technique is stereo-photogrammetry which uses overlapping of at least two images to calculate three-dimensional coordinates, similar to human eyesight. The other technique is called convergent photogrammetry and it relies on two or more cameras positioned at angles converging on a common object of interest. Both techniques result in 2D images of the 3D object and use mathematical equations to calculate the third dimension. Another common requirement is that the images are related to a known coordinate system and a known scale. Typically several targets are measured so their 3D coordinates are known and the targets are positioned so that several are visible for each image that is used. The images can then be calibrated and corrected to the known reference targets.

Photogrammetry has been used predominantly in the area of aerial photogrammetry for performing large scale geographical surveys. A plane properly equipped with a photographic unit takes a series of overlapping images, preferably sixty percent overlapping, and, based on later surveys, visible objects in the images are assigned 3D coordinates. All other points within the overlapping images can then be calculated based on these known coordinates. In addition to the metric data (i.e., distances, elevations, areas, etc.), photogrammetry also allows for the acquisition of interpretive data (i.e., textures, colors, patterns, etc.) by virtue of the images captured.

Similarly, close-range photogrammetry can be used to capture 3D data and features of relatively smaller objects. The process is similar to aerial photogrammetry in that the physical process involves two main steps. First, a network of control points is defined to establish a reference system in which the object to be measured is contained. The second step involves the actual acquiring of the images of the object to be measured. After the series of images are acquired, the images are converted into a digital format (if not already in a digital format). The images are then processed via computer software to correct for camera distortion, and common points in each image are tied together. The relative position and orientation of each image can be calculated, known as relative orientation (RO). The final step to the photogrammetric process is called absolute orientation (AO) in which the relative orientation of each group of images is fit (scaled, oriented) into the space of the control coordinates. One skilled in the art will recognize that this type of photogrammetry is also known as softcopy photogrammetry or analytical photogrammetry.

The process and mathematical procedures are covered only briefly in this section, as a detailed understanding of photogrammetry is not required to understand the present invention. Additionally, the photogrammetric process is well known by those skilled in the art. Commercial vendors of photogrammetry systems have enabled relative novices to achieve highly accurate results. All systems still require skill in the two steps of the physical process (acquiring the images and establishing the references). However, once the images are acquired, the software automates much of the process of generating the photogrammetric model. For example, edge detection techniques are used so the user does not have to manually select points in multiple photos, which makes the process almost automatic and more economical. Some commercial vendors of photogrammetry systems are Rollei, GSI, Vexcell and Imetric.

U.S. Pat. No. 5,805,289 discloses a hybrid system that uses both individual coordinate measurements along with image measurement systems. Calibrated spatial reference devices (SRDs) of known dimensions having targets at known relative locations are attached to a large structure to be measured. An accurate coordinate measurement machine (CMM) provides absolute 3D measured locations of the targets used to convert the relative photogrammetry locations into absolute 3D locations. Image detection techniques are used to identify objects selected by a user. Dimensions of an object and distances between selected objects are automatically calculated.

Although there are a variety of systems to generate a 3D model using photogrammetry and at least one for combining individual point measurements with photogrammetric models, what is needed is a system to address the problem of placing CAD models of a part on a 3D model of an object which contains the part, such that a 3D representation of an external configuration of a legacy system can be generated cost effectively.

### SUMMARY OF INVENTION

An apparatus and method is provided to place three-dimensional part models qon a three-dimensional object model, thereby creating a 3D representation of an external configuration of the object.

A method and system for creating three-dimensional models is provided. A three-dimensional object model is generated from a plurality of images of an object, wherein the images contain a part which is at least partially visible. At least three three-dimensional coordinates are created from the plurality of images. A CAD model of the part is accessed. Coordinates on the CAD model which correspond to each of the three-dimensional coordinates are identified. A transformation matrix is calculated between the respective ones of the three-dimensional coordinates and the coordinates on the CAD model. The transformation matrix is then applied to the CAD model to place the CAD model in the object model thus creating a composite model.

### BRIEF DESCRIPTION OF DRAWINGS

FIG. 1 is a graphic illustration of an embodiment of the present invention;

FIG. 2 is a flow chart illustrating an exemplary method of the present invention;

FIG. 3 is a flow chart illustrating another exemplary method of the present invention; and

FIG. 4 is an embodiment of a system of the present invention.

### DETAILED DESCRIPTION

Before reviewing in detail the methods and systems of the present invention, an overview of the invention will be presented. The overview refers to specific components of an external engine. However, the invention is not limited to that environment and may be used in other types complex and/or large systems as will be appreciated by one skilled in the art.

As an example, a user may be interested in placing a CAD model of a carburetor (part) on an engine (object). Images of the engine containing at least some visible portions of a carburetor (part) are acquired. The images are then processed by a photogrammetry system forming a photogrammetric model of the engine (object model). Typically, two images showing perspective views of the engine and carburetor are used to create 3D coordinates. Both images show a first point, a second point and a third point on the carburetor. Pixels are selected from each image that best represent the points on the carburetor. Each set of pixels is used to generate the 3D coordinates. For example, a first pixel in a first image and a first pixel in a second image are used to generate the 3D coordinates for the first point on the carburetor. A CAD model of the carburetor is accessed in a known manner. Coordinates from the CAD model are selected that correspond to the three points on the carburetor and the 3D coordinates generated from the pixels.

A transformation matrix is then calculated based on the coordinates of the CAD model and the 3D coordinates. The transformation matrix is an algorithm that fits (scales, positions, and orients) the CAD model coordinates to the 3D coordinates, as is known in the art. The transformation matrix is applied to the CAD model which places the CAD model of the carburetor into the reference frame of the engine model. Specifically, the transformation matrix fits (scales, positions, and orients) the CAD model coordinates to the 3D coordinates. The resulting composite model now has the CAD model of the carburetor on the engine. The engine model, being generated by photogrammetry, retains its photo-like characteristic. The CAD model of the carburetor retains its computer generated image characteristics.

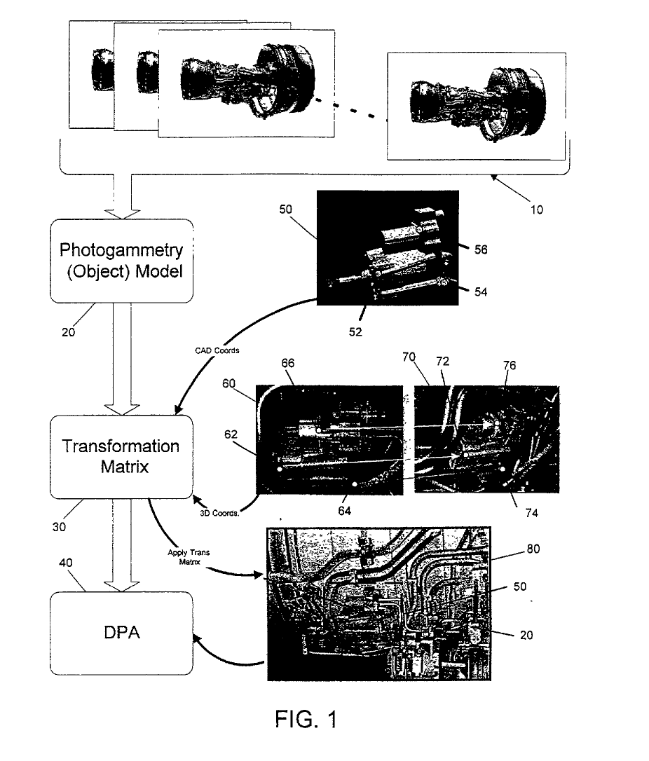

FIG. 1 shows a graphic illustration of significant steps of an embodiment of the present invention. A series of images 10 contains a plurality of individual images. Although the actual number of individual images is not significant, one skilled in the art will recognize that at least two images are acquired. Preferably, a complete representation of the object, for example an aircraft engine, is shown in the images 10. The images 10 are then used to create a photogrammetric model (also known as an object model) 20 of the object using known techniques. A CAD model 50 of a part (not shown explicitly but represented by CAD model 50 and shown in images 60 and 70) is accessed in a known manner, such as retrieval from a Digital Parts Assembly (DPA), database, graphic file, and the like. Pixels 62, 64, 66, 72, 74, and 76 are identified on images 60 and 70, respectively, to create 3D coordinates relative to the photogrammetric object model 20. At least two such pixels, for example 62 and 72 each corresponding to the same point on the part, are identified from two related images selected from the plurality of images 10. Related images are two or more images that show the same area from a different view. However, additional pixels could be identified that corresponded to the same point on additional images. Each set of pixels is processed by the photogrammetry software to generate the 3D coordinates of the points on the part. At least three of the 3D coordinates are used to provide for scaling, position, and orientation of the part. CAD model coordinates 52, 54 and 56 are identified corresponding to the same points on the part that were used to generate the 3D coordinates.

Next a transformation matrix 30 is calculated, using known techniques, to relate the CAD model coordinates 52, 54 and 56 to the 3D coordinates generated from pixels 62, 64, 66, 72, 74, and 76. The transformation matrix 30 is applied to the CAD model 50 thereby placing the CAD model 50 into the reference frame of the object model 20. The CAD model 50 is fit (scaled, positioned, and oriented) relative to the 3D coordinates generated from pixels 62, 64, 66, 72, 74, and 76. Optionally, the object model 20 is alternatively scaled to best fit the CAD model 50. Composite model 80 is object model 20 with the externally placed CAD model 50. Composite model 80 is then stored in a data storage device in a retrievable format such as a DPA 40, database, graphic file, and the like. Optionally, the CAD model 50 is alternatively stored with its transformed values in the data storage device.

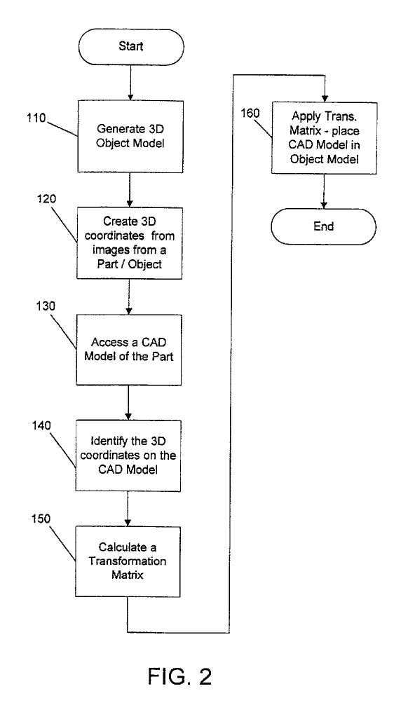

The invention will be further described with reference to FIG. 2, a flow chart illustrating a method for externally placing 3D CAD models. The method starts and proceeds to generate a photogrammetry model (object model) from images acquired of the object using known techniques and/or systems, in step 110. The images have a part that is at least partially visible in at least two of the images. The images are preferably captured by a digital camera but may also be scanned in or generated in other known ways. In step 120, 3D coordinates of the part are created, using known photogrammetry techniques, by selecting at least two pixels, one each from at least two images that show a corresponding visible point on the part in each image. For example, a purchased photogrammetry system, from vendors as noted above, could be used to generate the 3D coordinates from the images based on a user's selection of pixels, or by known automated techniques such as edge detection techniques, or combinations of manual and automatic selection. In step 130, a CAD model of the part is accessed. Next, in step 140, at least three coordinates are identified on the CAD model that correspond to the 3D coordinates previously created. In step 150, a transformation matrix is calculated using the two sets of coordinates, the 3D coordinates and CAD model coordinates, using known graphic and image processing techniques. The transformation matrix provides a means for transforming from the CAD coordinate reference frame to the object model coordinate reference frame. In step 160, the transformation matrix is applied to the CAD model thereby placing the CAD model into the object model reference frame. The composite model formed by step 160 has the CAD model placed, scaled and oriented in the object model.

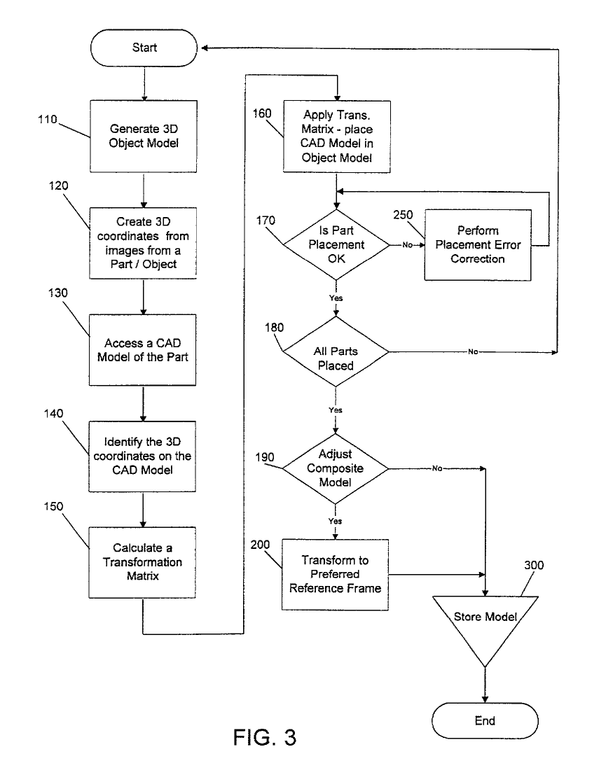

Referring to FIG. 3, a flow chart is shown that provides for another exemplary method of the present invention. Steps 110 to 160 perform the same as described above. Therefore, the description will not be repeated. In step 170, a user is queried for acknowledgment that the composite model has the CAD model of the part placed correctly on the object model. If the part placement is not acceptable in step 170, an error correction routine, in step 250, provides for correction of the part placement. The error correction is performed by known techniques. For example, the error correction may be implemented by known mathematical techniques such as least squares adjustment or may require a complete or partial repetition of steps 110-160. If the part placement is acceptable, a decision is made on whether all parts have been placed, in step 180. If all parts are not placed, the part placement steps 110-170 are repeated for another part. Placing additional CAD models on the object model allows for the individual CAD models of individual visible parts of the object to be properly positioned, scaled, and oriented relative to the object model and each other. A composite model of all placed CAD models of the visible parts on the object model is thus formed. When all parts have been placed, the user can optionally select to adjust the composite model in step 190. In step 200, the composite model is transformed by another mathematical operation known in the art to a preferred reference frame as entered by the user. For instance, an object may have a particular point from which all others are referenced, such as the end of a shaft, mounting flange, bearing journal, and the like. For many uses this additional transformation would be very beneficial. For example, the composite model adjusted to the preferred reference frame could correspond to existing drawings which would facilitate usage by engineers and technicians already familiar with the existing systems. The composite model is thus adjusted so that all coordinates are referenced to the preferred point. If the user elects not to adjust the composite model, in step 190 or at the completion of step 200, the composite model is stored in a data storage device, such as a disk, CD ROM, tape, and the like, in step 300. Preferably, the composite model is stored in a format that facilitates retrieval, such as a DPA, relational database, and the like. Also, the CAD model could be stored with the transformed values.

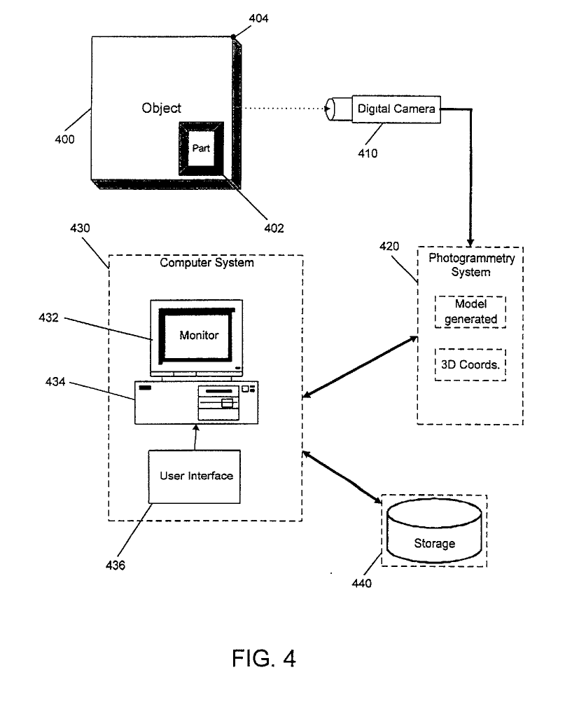

Referring to FIG. 4, an exemplary system is shown for placing three-dimensional part models of the present invention. To facilitate an understanding of the invention, many aspects of the invention are described in terms of sequences of actions to be performed by elements of a computer system. It will be recognized that in each of the embodiments, the various actions could be performed by specialized circuits (e.g., discrete logic gates interconnected to perform a specialized function), by program instructions being executed by one or more processors, or by a combination of both. Moreover, the invention can additionally be considered to be embodied entirely within any form of a computer readable storage medium having stored therein an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of an embodiment may be referred to herein as “logic configured to” perform a described action, or alternatively as “logic that” performs a described action.

In FIG. 4, a plurality of digital images are acquired of an object 400 by an image acquisition device 410. Object 400 contains a part 402 which is at least partially visible. Image acquisition device 400 is represented as a digital camera. However, a scanner, digital video device, and the like could also be used. The digital images are stored in a conventional manner, such as flash memory, disk, serial communication to a storage device, and the like, for access by photogrammetry system 420. The photogrammetry system 420 may be configured in a variety of embodiments as will be appreciated by those skilled in the art. For example, the photogrammetry system 420 may be a software program running on computer system 430 or may be a separate workstation having its own processor, monitor, and the like. The photogrammetry system 420 generates a three-dimensional object model from the plurality of digital images of the object 400 by conventional photogrammetry techniques. The computer system 430 is operatively connected to the photogrammetry system 420 by conventional means such as shared memory, network, removable disk, and the like.

The computer system 430 has a monitor 432, at least one processor 434, and a user interface 436. The monitor 432 is capable of displaying graphic images, text, and the like. The processor 434 is capable of executing logic instructions, calculations, input/output (I/O) functions, graphic functions, and the like. Preferably, user interface 436 has at least a keyboard and a pointing device such as a mouse, digitizer, or the like. Preferably computer system is optimized for performing graphic intensive operations, such as having multiple processors, including dedicated graphics processors, large high resolution monitors, and the like as known in the art.

The computer system 430 has logic configured to create three or more 3D coordinates from the plurality of images. The images are displayed on monitor 432 and pixels on the images are selected by user interface 436. At least two images are selected from the plurality of images of the object 400 that contain visible portions of the part 402. A user selects various pixels from each image that best represents the points on the part 402. Each set of pixels is used to generate the 3D coordinates. For example, a first pixel in a first image and a first pixel in a second image are used to generate the 3D coordinates for the first point on the part 402. Preferably, the photogrammetry system 420 is integrated into the computer system 430 and may be used to generate the 3D coordinates. The computer system 430 has logic configured to access a CAD model of the part 402. The CAD model may be accessed in a conventional manner from a disk, magnetic tape, CD-ROM, network, database, DPA, and the like. The CAD model is displayed on monitor 432. A user identifies coordinates on the CAD model of the part 402 which correspond to the 3D coordinates generated from the images containing part 402. The computer system 430 also has logic configured to calculate a transformation matrix between the 3D coordinates and the coordinates on the CAD model of part 402. The transformation matrix is an algorithm that fits (scales, positions, and orients) the CAD model coordinates to the 3D coordinates. The computer system 430 has logic configured to apply the transformation matrix to the CAD model. Applying the transformation matrix places the CAD model of the part 402 in the object model thus creating a composite model.

Additionally, the system may include a storage device 440 for storing the composite model and/or CAD model with transformed values. Storage device 440 may also be used to store the digital images, photogrammetry system 420, photogrammetric model, CAD model, and the like. Preferably, storage device 440 is included in computer system 430 and is a disk, magnetic tape, CD-ROM, and the like. However, storage device 440 may be located on a separate system from the computer system 430, as is known in the art. Optionally, the computer system 430 may have logic configured to reduce the error in the transformation matrix using known error correction algorithms such as a least squares algorithm. Further, the computer system 430 may have logic configured to transform the composite model into a preferred reference frame wherein all coordinates on the composite model are calculated relative to a preferred reference point 404 of the object 400. For instance, preferred reference point 404 may correspond to (0, 0, 0) in the conventional system of measuring object 400. A user enters this information through user interface 436 and the relative coordinates on the part 402 and on object 400 are recalculated based on the new coordinate system. The composite model is then converted into a preferred coordinate system that relates to a conventional or preferred reference frame that is familiar to the user.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for creating at least one three-dimensional model comprising the steps of:
generating a three-dimensional object model from a plurality of images of an object, wherein the images also contain a part which is at least partially visible;
creating at least three three-dimensional coordinates from the plurality of images;
identifying coordinates on an accessed computer aided design (CAD) model of the part which correspond to each of the three-dimensional coordinates;
calculating a transformation matrix between the respective ones of the three-dimensional coordinates and the coordinates on the CAD model; and
applying the transformation matrix to the CAD model to place the CAD model in the object model thus creating a composite model.

2. The method of claim 1 further comprising the step of:
storing the CAD model with transformed values in a storage device, the transformed values resulting from the applying step.

3. The method of claim 1 further comprising the step of:
storing the composite model in a storage device.

4. The method of claim 1, wherein the plurality of images are created by at least one digital camera.

5. The method of claim 1, wherein the images are created by scanning photographs of the object.

6. The method of claim 1 further comprising the step of:
reducing the error in the transformation matrix by a applying an error reducing algorithm.

7. The method of claim 6, wherein the error reducing algorithm is a least squares algorithm.

8. The method of claim 1 further comprising the step of:
transforming the composite model into a preferred reference frame, wherein all coordinates on the composite model are calculated relative to a preferred reference point of the object.

9. The method of claim 1, wherein the step of generating the three-dimensional object model from the plurality of digital images of the object comprises:
matching points and features of the plurality of digital images to create the three-dimensional object model.

10. A system for creating three-dimensional models comprising:
a photogrammetry system for generating a three-dimensional object model from a plurality of images of an object acquired from an image acquisition device, wherein the images also contain a part which is at least partially visible, wherein the photogrammetry system is operatively connected to the image acquisition device;
a computer system, operatively connected to the photogrammetry system, the computer system comprising:
at least one processor;
a user interface;
a monitor;
logic configured to create three or more three-dimensional coordinates from the plurality of images;
logic configured to access a CAD model of the part;
logic configured to identify coordinates on the CAD model which correspond to the three-dimensional coordinates;
logic configured to calculate a transformation matrix between the three-dimensional coordinates and the coordinates on the CAD model; and
logic configured to apply the transformation matrix to the CAD model thus placing the CAD model in the object model and creating a composite model.

11. The system of claim 10 further comprising:
a storage device, wherein the storage device is operatively connected to the computer system.

12. The system of claim 11, wherein the storage device is integrated with the computer system.

13. The system of claim 10, wherein the image acquisition device is at least one digital camera.

14. The system of claim 10, wherein the image acquisition device is a scanner.

15. The system of claim 10, wherein the computer system further comprises:
logic configured to reduce the error in the transformation matrix.

16. The system of claim 15, wherein the logic configured to reduce the error in the transformation matrix further comprises:
a least squares algorithm.

17. The system of claim 10, wherein the computer system further comprises:
logic configured to transform the composite model into a preferred reference frame, wherein all coordinates on the composite model are calculated relative to a preferred reference point of the object.

18. The system of claim 10, wherein the photogrammetry system is integrated with the computer system.

19. A system for creating three-dimensional models comprising:
an image acquisition device;
a photogrammetry system for generating a three-dimensional object model from a plurality of images of an object acquired from the image acquisition device, wherein the images also contain a part which is at least partially visible, wherein the photogrammetry system is operatively connected to the image acquisition device;
a computer system, operatively connected to the photogrammetry system, the computer system comprising:
at least one processor;
a user interface;
a monitor;
means for creating three or more three-dimensional coordinates from the plurality of images;
means for accessing a CAD model of the part;
means for identifying coordinates on the CAD model which correspond to the three-dimensional coordinates;
means for calculating a transformation matrix between the three-dimensional coordinates and the coordinates on the CAD model; and
means for applying the transformation matrix to the CAD model thus placing the CAD model in the object model and creating a composite model.
